(19) United States
(12) Patent Application Publication
(10) Pub. No.: US 2023/0228791 A1
(43) Pub. Date: Jul. 20, 2023

(54) Method For Determining an Orientation Angle of Inertial Sensors To One Another

(71) Applicant: Robert Bosch GmbH, Stuttgart (DE)

(72) Inventor: Jan Ruppelt, Oberstenfeld (DE)

(21) Appl. No.: 18/148,151

(22) Filed: Dec. 29, 2022

(30) Foreign Application Priority Data
Jan. 20, 2022 (DE) 10 2022 200 656.9

(51) Int. Cl. G01P 15/18; G01P 15/08; G01P 3/44

(52) U.S. Cl. CPC G01P 15/18; G01P 15/08; G01P 3/44

(57) ABSTRACT

A method for determining the orientation of at least two inertial sensors in a device or between at least two devices, each having at least one inertial sensor, includes a) receiving first raw acceleration data and/or rotation rate data of a first inertial sensor in three directions during regular operation of the device; b) simultaneously to step a), receiving second raw acceleration data and/or rotation rate data of a second inertial sensor in three directions during regular operation of the device; c) time-synchronizing the first and second raw acceleration data and/or rotation rate data so that the time-synchronized raw acceleration data of the first inertial sensor and of the second inertial sensor are generated; and d) calculating relative orientation angles in three spatial directions between the first inertial sensor and the second inertial sensor with the time-synchronized raw acceleration data.

This application claims priority under 35 U.S.C. § 119 to application no. DE 10 2022 200 656.9, filed on Jan. 20, 2021 in Germany, the disclosure of which is incorporated herein by reference in its entirety.

### BACKGROUND

Here, a new method for estimating the orientation of a plurality of inertial sensors (IMUs) to one another is presented. Inertial sensors are sensors for measuring accelerations and/or rotation rates.

Inertial sensors are used in many different applications, for example, in mobile phones, smartwatches, fitness trackers and similar products, but also in high-priced products and very complex products, such as vehicles, in particular in motor vehicles, ships and airplanes.

In all applications, the problem of converting data from a plurality of inertial sensors, which are arranged differently, to one another, of comparing the measured values of various sensors to one another, and/or of converting or comparing the measured values of a plurality of inertial sensors to one another is encountered.

A key problem in this context is to determine the knowledge about the orientation of various inertial sensors to one another. This knowledge is required in order to be able to use the signals of various inertial sensors in calculations with one another and to be able to perform, based thereon, exact data processing of the data provided by the inertial sensors. In particular, due to installation inaccuracies and manufacturing inaccuracies, this knowledge often cannot be assumed a priori. It is therefore helpful and often necessary for complex applications to be able to calculate this knowledge (after the fact as well) if various inertial sensors are already fixedly arranged relative to one another, but their exact arrangement relative to one another is not known. This is in particular necessary in order to be able to determine even small manufacturing tolerances and their effect on the exact arrangement of the sensors to one another

One known method is the use of a so-called motion simulator to determine the arrangements to one another. A motion simulator is typically a machine in which an object (e.g., a device such as a mobile phone, a smartwatch, or a different product) can be moved according to a predetermined profile. Preferably, a motion simulator is configured to adjust accelerations in any spatial directions and any rotation rates.

As the object is moved according to the predetermined profile, the signal outputs of the various inertial sensors are then monitored and recorded. With the recorded signal outputs and the knowledge of the predetermined motion profile as well as an exact temporal alignment of the recorded signal outputs with the motion profile as input data, the relative arrangement of the inertial sensors to one another can then be calculated with the help of various mathematical methods (in particular with iterative Gauss-Newton methods and/or Levenberg-Marquardt algorithms).

However, such methods are very complex to perform. Typically, such methods cannot be carried out for each individual product, in particular if the products are rather low-priced products, such as mobile phones, smartwatches or fitness trackers. With such products, it is rather necessary that such methods are carried out on a representative basis for individual products of an entire product series and it is then ensured for the entire product series via precise adherence to manufacturing tolerances that the arrangement of the inertial sensors to one another is sufficiently exact. Individually (i.e., for each individual product produced), such methods can usually only be performed for very high-priced, complex products.

### SUMMARY

For this purpose, a reliable new method is now to be presented, which at least partially solves the described problems.

The method described herein for determining the orientation of at least two inertial sensors in one device or between at least two devices, each having an inertial sensor, to one another comprises the steps of:
a) receiving first raw acceleration data of a first inertial sensor in three directions during regular operation of the device;
b) simultaneously to step a), receiving second raw acceleration data of a second inertial sensor in three directions during regular operation of the device;
c) time-synchronizing the raw acceleration data of the first inertial sensor and the raw acceleration data of the second inertial sensor so that the time-synchronized raw acceleration data of the first inertial sensor and of the second inertial sensor are generated; and
d) calculating relative orientation angles in three spatial directions (ϕ, θ, ψ) between the first inertial sensor and the second inertial sensor with the time-synchronized raw acceleration data.

The particularity of the described method is that raw acceleration data are collected in regular operation, which are used to calculate the relative orientation angle. This is discussed in more detail below.

Movements to determine the relative arrangement of the inertial sensors to one another may occur, for example, by driving a vehicle.

Where appropriate, a very regular (randomly occurring, i.e., not pre-planned) trip may be used to determine raw data of the respective inertial sensors. Where appropriate, a predetermined test drive may also be planned and conducted. This then results in a predetermined motion profile, which is by far not as exact as a motion profile generated with a motion simulator but not quite as random as a motion profile randomly generated by using the product in the field.

A further significant difference compared to known methods is that a relative orientation angle of the first inertial sensor and of the second inertial sensor to one another is determined directly. The method can be performed for two inertial sensors. However, in principle, it can also be extended to a higher number of inertial sensors, wherein a plurality of method executions may then occur in succession, in which a subset of the inertial sensors (e.g., a subset of two inertial sensors each) is respectively processed with the described method. The inertial sensors may be arranged in one device. However, the method is equally applicable to inertial sensors in different devices, wherein these different devices are then preferably fixedly or rigidly installed in a higher-level device (e.g., a vehicle).

In known methods performed, for example, with a described motion simulator, a calculation of orientation angles of each individual inertial sensor relative to a (superordinate) coordinate system, which is, for example, a coordinate system of the motion simulator or a recording of the motion simulator for the product or device, is usually performed.

Such a relative orientation angle may indeed also be determined based on an addition of orientation angles of each individual inertial sensor in a superordinate coordinate system. However, this is more complex.

It is particularly preferred if the regular operation in step a) is the use of the finished device in a test operation performed individually for each individual device.

This may, for example, be the use of a vehicle on a test track, which is done to test a whole range of systems and equipment of the vehicle.

In addition, it is preferred if the regular operation is an operating phase of the device shortly after the regular initial start-up of the device by an end user.

Moreover, it is preferred if the regular operation is any operating phase of the device during the regular operation of the device in its intended use.

These different operating modes are considered here as regular operation within the meaning of the disclosure. Further types of regular operation are conceivable. A distinction is to be made between the regular operation and a mere test operation performed exclusively or almost exclusively for testing/checking the inertial sensors, for example with a described motion simulator.

Preferably, in step d), the synchronized raw acceleration data are established in the form of two vectors \vec{f}_{ib,A}^{b}(fₓ, f_{y}, f_{z})_{ib}^{b} for the first inertial sensor and \vec{f}_{ib,B}^{b}(fₓ, f_{y}, f_{z})_{ib}^{b} for the second inertial sensor, and the orientation of the two inertial sensors is described by a matrix Ĉ_{b,B}^{b,A} according to the formula:

\vec{f}_{ib,A}^{b}=Ĉ_{b,B}^{b,A}\vec{f}_{ib,B}^{b}.

The matrix Ĉ_{b,B}^{b,A} is used to convert raw acceleration data of the second inertial sensor into a coordinate system of the first inertial sensor. In the method described here, there is, in particular, no matrix that enables conversion to a superordinate coordinate system, but the calculations of the relative orientation angles of the inertial sensors to one another take place directly on the basis of own coordinate systems of the inertial sensors.

The basic idea of both approaches is to determine the orientation of two inertial sensors to one another. Mathematically, the orientation may be described with a direction cosine matrix (DCM). The direction cosine matrix (DCM) includes the Euler angles (b, 0, xy) describing the orientation of a solid body relative to a coordinate system. Each inertial sensor can be considered as a solid body having its own body coordinate system.

Here, the case of two inertial sensors with 6 output parameters each is to be considered, namely with 3 acceleration parameters for the three spatial directions and with 3 rotation rate parameters for the three rotation directions in space. One inertial sensor is referred to as IMU A and the other inertial sensor is referred to as IMU B.

The acceleration parameters of the two inertial sensors measure the specific forces \vec{f}_{ib,A}^{b}(fₓ, f_{y}, f_{z})_{ib}^{b} for IMU A (first inertial sensor) and \vec{f}_{ib,B}^{b}(fₓ, f_{y}, f_{z})_{ib}^{b} for IMU B (second inertial sensor). Moreover, inertial sensors are often capable of measuring rotation rate parameters.

The idea of the method discussed herein is now to calculate the orientation of the sensors as a matrix DCM Ĉ_{b,B}^{b,A} based on these specific forces.

Assuming IMU A and IMU B are in the exact same orientation, this means that the measured accelerations of IMU A and IMU B correspond to one another. Accordingly, the Euler angles (ϕ, θ, ψ) must be equal to ZERO. This results in a matrix DCM Ĉ_{b,B}^{b,A}=I_{3×3}, the unit matrix.

With Euler angles not equal to ZERO for the following equation, the unit matrix cannot be assumed. However, it is possible to establish the following equation, which describes the mathematical relationship between the two measured accelerations of the different inertial sensors.

\vec{f}_{ib,A}^{b}=Ĉ_{b,B}^{b,A}\vec{f}_{ib,B}^{b}

The mathematical relationship for measured rotation rates of different inertial sensors is described by the following equation.

\vec{ω}_{ib,A}^{b}=Ĉ_{b,B}^{b,A}\vec{ω}_{ib,B}^{b}

The matrix Ĉ_{b,B}^{b,A} is the transformation matrix with which the accelerations measured with the one inertial sensor IMU B can be converted into the coordinate system of the other inertial sensor IMU A. Converted into the coordinate system of this inertial sensor IMU A, the accelerations measured with both inertial sensors IMU A and IMU B must be nearly identical in an idealized consideration (without fault, thermal noise, etc.). Minor deviations may result from different sensor noise from IMU A and IMU B. In an idealized consideration, however, the accelerations measured with both inertial sensors IMU A and IMU B are identical.

In this context, it is preferred if an angle-dependent residual vector r(ϕ,θ,ψ) is calculated according to the following form in order to estimate the matrix Ĉ_{b,B}^{b,A}:

r(ϕ,θ,ψ)=Ĉ_{b,B}^{b,A}\vec{f}_{ib,B}^{b}−\vec{f}_{ib,A}^{b}.,

wherein the following square error function is established based on the residuals:

$$f ( ϕ , θ , ψ ) = \frac{1}{2} {r ( ϕ , θ , ψ )}^{⊤} r ( ϕ , θ , ψ ) ,$$

wherein the following Jacobi matrix is established based on this square error function:

$$J = ( \begin{matrix}\partial \frac{f ( ϕ , θ , ψ )}{\partial ψ} & \partial \frac{f ( ϕ , θ , ψ )}{\partial θ} & \partial \frac{f ( ϕ , θ , ψ )}{\partial ψ}\end{matrix} ) ,$$

wherein the Jacobi matrix is estimated using an iterative estimation method.

The Jacobi matrix serves as input parameter for the iterative estimation method. Iterative estimation methods are capable of estimating the orientation of the two inertial sensors IMU A and IMU B (first inertial sensor and second inertial sensor) relative to one another based on this Jacobi matrix.

Moreover, it is preferred if an iterative Gauss-Newton estimator (GN estimator) is used in step d) to calculate the relative orientation angles (4, 0, Y).

In the iterative Gauss-Newton estimator (GN estimator), this is done according to the following iterative approach:

xₖ₊₁=xₖ−(J(xₖ)^{T}J(xₖ))⁻¹J(xₖ)^{T}r(xₖ)

In addition, it is preferred if an iterative Levenberg-Marquardt estimator (LM estimator) is used in step d) to calculate the relative orientation angles (ϕ, θ, ψ).

In the iterative Levenberg-Marquardt estimator (LM estimator), this is done according to the following iterative approach:

xₖ₊₁=xₖ−(J(xₖ)^{T}J(xₖ)+λdiag(J(xₖ)^{T}J(xₖ)))⁻¹J(xₖ)^{T}r(xₖ)

The Levenberg-Marquardt estimator is an improvement of the Gauss-Newton estimator, in which the step width k is in particular defined dynamically.

In both estimators, the described estimation function is respectively performed regularly repeatedly and the estimation result is continuously improved with each iteration step. The vector X given here indicates the orientation angles between the two inertial sensors in the three spatial directions:

When performing the estimation with the estimators, a time curve of raw acceleration data of the two inertial sensors IMU A and IMU B is utilized or processed. In a first iteration step, the unit matrix is used as the transformation matrix between IMU A and IMU B if no prior knowledge about the orientation of the sensors exists. If prior knowledge about the orientation between IMU A and IMU B is available, a transformation matrix based on the prior knowledge about the Euler angles (ϕ₀, θ₀, ψ₀) is preferably used. This results in an initial matrix DCM Ĉ_{b,B}^{b,A} (ϕ₀, θ₀, ψ₀):

$${\hat{C}}_{b , B}^{b , A} ( {ϕ}_{0} , {θ}_{0} , {ψ}_{0} ) = ( \begin{matrix}c {θ}_{0} c {ψ}_{0} & - c {ϕ}_{0} s {ψ}_{0} + s {ϕ}_{0} s {θ}_{0} c {ψ}_{0} & s {ϕ}_{0} s {ψ}_{0} + c {ϕ}_{0} s {θ}_{0} c {ψ}_{0} \\ c {θ}_{0} s {ψ}_{0} & c {ϕ}_{0} c {ψ}_{0} + s {θ}_{0} s {ψ}_{0} & - s {ϕ}_{0} c {ψ}_{0} + c {ϕ}_{0} s {θ}_{0} s {ψ}_{0} \\ - s {θ}_{0} & s {ϕ}_{0} c {θ}_{0} & c {ϕ}_{0} c {θ}_{0}\end{matrix} ) ,$$

where sϕ₀ is sin(ϕ₀) and cϕ₀ is cos(ϕ₀), sθ₀ is sin(θ₀) and cθ₀ is cos(θ₀), sψ₀ is sin(ψ₀) and cψ₀ is cos(ψ₀).

Prior knowledge regarding the orientation between IMU A and IMU B can, for example, originate from a rough estimate, which can, for example, originate from structural features of the device. Such prior knowledge may, for example, comprise the information that IMU A and IMU B are soldered at a specific angle to one another (e.g., approximately 90 degrees) on a circuit board. The method described may then be used, for example, to compensate for manufacturing tolerance-related deviations.

In the following, the Euler angles (ϕ, θ, ψ) are expressed by the vector X. In an iterative method, the orientations of the two inertial sensors IMU A and IMU B (first inertial sensor and second inertial sensor) are calculated based on the movement of the solid body representing the two inertial sensors mathematically.

Moreover, it is preferred if the time synchronization in step c) takes place by means of a GNSS time parameter (time stamp), which the first inertial sensor and the second inertial sensor respectively receive via an associated GNSS receiver.

Preferably, the inertial sensors are each part of sensor modules for determining navigation data, which may also include GNSS receivers. In GNSS receivers, there is always also very exact time information (GNSS time or GNSS time parameters) available, which is required to analyze the GNSS data received from satellites. This exact time information is preferably received by each GNSS receiver from the GNSS satellites of the GNSS system. It is preferable to process this GNSS time parameter along with the raw data received from the inertial sensors in order to perform the time synchronization in step c) based thereon. The received raw acceleration data of the first inertial sensor and the received raw acceleration data of the second inertial sensor then each preferably include time information based on the GNSS time parameter. During synchronization, the raw acceleration data may be synchronized to one another or with one another based on the deviation of the time information of both raw data packets.

It is also preferred if the time synchronization in step c) takes place with an auto-correlation function that processes the first raw acceleration data and the second raw acceleration data.

In an auto-correlation function, time synchronization preferably takes place via a comparison of the first raw acceleration data and the second raw acceleration data. Typically, in doing so, raw acceleration data flows are compared to one another and patterns of raw acceleration data that must occur equally in the first raw acceleration data and the second raw acceleration data are compared to one another. A time allocation of the raw acceleration data to one another is thereby possible. A time shift parameter may thus be generated with which a set of raw acceleration data (first raw acceleration data or second raw acceleration data) may be time-shifted to achieve synchronization of the raw acceleration data.

In addition, it is preferred if rotation rate data of a first inertial sensor in three rotation directions are additionally received in step a), and wherein rotation rate data of a second inertial sensor in three rotation directions are additionally received in step b).

The method described may also be used for rotation rates instead of accelerations. When “accelerations,” “acceleration data,” “raw acceleration data” or comparable values/parameters are mentioned here, rotation rates, which can also be understood as rotation rate accelerations, are also included to the extent technically correct.

The residual vector is then given by

r(ϕ,θ,ψ)=Ĉ_{b,B}^{b,A}\vec{ω}_{ib,B}^{b}−\vec{ω}_{ib,A}^{b}

However, better estimates of the orientation of IMUs to one another can be expected from the accelerations.

Determination of the Jacobi matrix takes place when using rotation rates in analogy to the above representation. The use of rotation rates instead of acceleration may have the disadvantage that when stationary (in the unmoved state), no estimation can be made (all rotation rates are ZERO). When using accelerations, the IMUs measure the gravitational acceleration of the earth, so that, even when stationary, a partial calculation of the orientation vectors is possible: depending on the orientation of IMU A and IMU B to the earth, the gravitational acceleration is coupled into different axes of the IMUs; this knowledge is indirectly utilized (increased information content of the acceleration measurement and enables the partial calculation of the orientation without movement of the solid bodies). Nevertheless, the described method can be applied with the use of rotation rates as accelerations and also has advantages in certain conditions, for example because large rotation rates occur and/or rotation rates are present particularly precisely as raw data.

In principle, the rotation rates of the sensors can be used as a source of information in addition to the accelerations. In this case, rotation rate data as well as “normal” (linear) acceleration data are preferably present. This procedure utilizes more data and may achieve higher accuracy of the method. The residual vector would then, for example, be as follows and has 6 elements rather than three elements:

$$r ( ϕ , θ , ψ ) = {( \begin{matrix}{\hat{C}}_{b , B}^{b , A} & {0}_{3 \times 3} \\ {0}_{3 \times 3} & {\hat{C}}_{b , B}^{b , A}\end{matrix} )}_{6 \times 6} {( \begin{matrix}{\vec{f}}_{ib , B}^{b} \\ {\vec{ω}}_{ib , B}^{b}\end{matrix} )}_{1 \times 6} - {( \begin{matrix}{\vec{f}}_{ib , A}^{b} \\ {\vec{ω}}_{ib , A}^{b}\end{matrix} )}_{1 \times 6}$$

The additional inclusion of the rotation rates increases the robustness of the method.

In addition, it is preferred if at least one further inertial sensor is arranged in the device and further raw acceleration data are also determined for the at least one further inertial sensor in a step b2), wherein steps c) and d) are also performed for the at least one further inertial sensor based on the further raw acceleration data.

Also described herein is a device with at least two inertial sensors configured to perform the described method.

Such a device has advantages over devices that are not capable of performing the described method, because any manufacturing tolerance-related orientation errors of the existing inertial sensors to one another can be corrected without expensive test methods obtained with a motion simulator. Particularly precise movement data are thus available from the inertial sensors in the device.

### BRIEF DESCRIPTION OF THE DRAWINGS

The disclosure and the technical environment are explained in further detail below with reference to the figures. The figures show preferred exemplary embodiments to which the disclosure is however not limited. Shown are:

FIG. 1: a flow chart of the described method;

FIG. 2: a device for performing the described method; and

FIGS. 3 and 4: schematically, experimental results which explain the ability to perform the described method.

### DETAILED DESCRIPTION

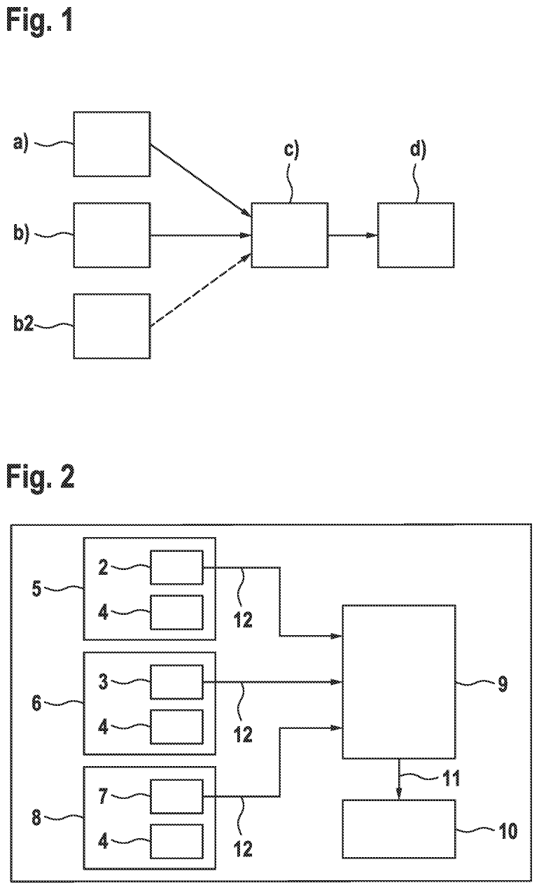

In FIG. 1, the flow of the described method is shown schematically. The method steps a), b), c) and d), which are performed in succession, can be seen, wherein step b2) is optionally performed (in the case of further inertial sensors/more than two inertial sensors).

FIG. 2 shows a described device 1 for performing the described method. The device 1 here has a total of three sensor modules 5, 6 and 8, namely a first sensor module 5, a second sensor module 6 and a further sensor module 8. The first sensor module 5 has a first inertial sensor 2. The first sensor module 6 has a second inertial sensor 3. The further sensor module 8 is representative of a flexible number of sensor modules, each of which likewise comprises further inertial sensors 7. According to this illustration, all sensor modules 5, 6 and 8 each have a GNSS receiver 4. However, this need not be the case. The GNSS receiver 4 is in particular not required if a time correlation of the raw data 12 determined with the inertial sensors 2, 3 and 7 takes place by means of auto-correlation techniques. The raw data 12 are each transferred to the orientation estimator 9, which determines the orientation angle vector 11 using the method described herein. The orientation angle vector 11 can subsequently be used in further data processing 10 in the device 1 to particularly precisely process the acceleration and rotation rate data determined with the inertial sensors 2, 3 and 7.

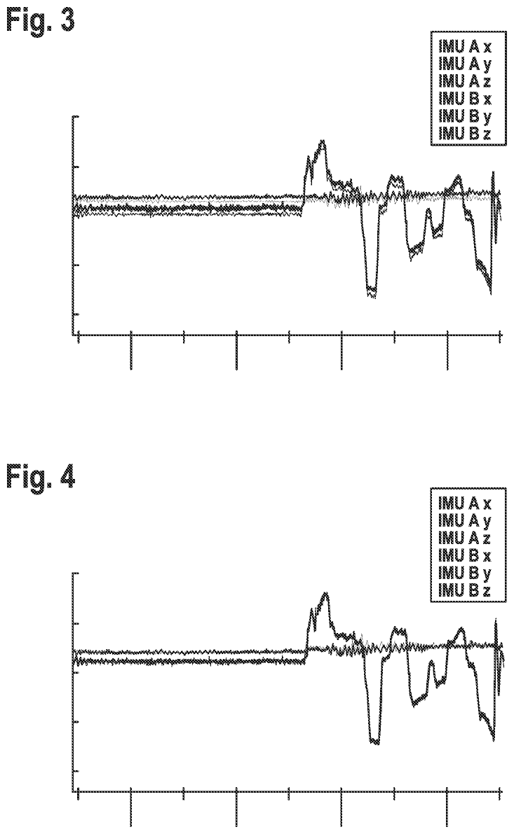

In FIG. 3 and FIG. 4, 6 raw data parameters are respectively compared, namely the accelerations of two inertial sensors IMU A and IMU B, in each case in the three spatial directions X, Y and Z.

In FIG. 3, a total of 6 recordings can be seen because, due to a manufacturing-related, very small deviation of the spatial directions of the sensors to another (ϕ, θ, ψ)=(−0.22059,0.36478, −1.2127), respectively given in angular degree (highest deviation for the angle ψ of −1.2127° (angular degree), the curves of the recordings of the two inertial sensors IMU A and IMU B for X, Y and Z are not exactly congruent.

Although FIG. 4 also depicts 6 recordings, only 3 recordings can be seen because the recordings for X, Y and Z are respectively exactly congruent. This was achieved by correcting the X, Y and Z recordings from IMU A and IMU B with one another with the aid of the matrix Ĉ_{b,B}^{b,A} obtained using the method described herein.

1. A method for determining the orientation of at least two inertial sensors in a device or between at least two devices that each have at least one inertial sensor, to one another, the method comprising:
receiving first raw acceleration data and/or rotation rate data from a first inertial sensor in three directions during regular operation of the device;
simultaneously to receiving the first raw acceleration data and/or rotation rate data, receiving second raw acceleration data and/or rotation rate data from a second inertial sensor in three directions during regular operation of the device;
time-synchronizing the first raw acceleration data and/or rotation rate data of the first inertial sensor and the second raw acceleration data and/or rotation rate data of the second inertial sensor so that the time-synchronized raw acceleration data and/or rotation rate data of the first inertial sensor and of the second inertial sensor are generated; and
calculating relative orientation angles in three spatial directions between the first inertial sensor and the second inertial sensor with the time-synchronized raw acceleration data and/or rotation rate data.

2. The method according to claim 1, wherein the regular operation of the device is the use of the finished device in a test operation performed individually for each individual device.

3. The method according to claim 1, wherein the regular operation of the device is an operating phase of the device shortly after the regular initial start-up of the device by an end user.

4. The method according to claim 1, wherein the regular operation of the device is any operating phase of the device during operation of the device in its intended use.

5. The method according to claim 1, wherein in the calculating of the relative orientation angles, the synchronized raw acceleration data are established in the form of a first vector \vec{f}_{ib,A}^{b}=(fₓ, f_{y}, f_{z})_{ib}^{b} for the first inertial sensor and a second vector \vec{f}_{ib,B}^{b}(fₓ, f_{y}, f_{z})_{ib}^{b} for the second inertial sensor, and the relative orientation of the first and second inertial sensors is described by a matrix Ĉ_{b,B}^{b,A} according to the formula:
\vec{f}_{ib,A}^{b}=Ĉ_{b,B}^{b,A}\vec{f}_{ib,B}^{b}

6. The method according to claim 5, wherein an angle-dependent residual vector r(ϕ, θ, ψ) is calculated according to the following formula to estimate the matrix Ĉ_{b,B}^{b,A}:
r(ϕ,θ,ψ)=Ĉ_{b,B}^{b,A}\vec{f}_{ib,B}^{b}−\vec{f}_{ib,A}^{b},
wherein a square error function is established based on the angle-dependent residual vector as:
$$f ( ϕ , θ , ψ ) = \frac{1}{2} {r ( ϕ , θ , ψ )}^{⊤} r ( ϕ , θ , ψ ) ,$$
wherein a Jacobi matrix is established based on this square error function as:
$$J = ( \begin{matrix}\partial \frac{f ( ϕ , θ , ψ )}{\partial ψ} & \partial \frac{f ( ϕ , θ , ψ )}{\partial θ} & \partial \frac{f ( ϕ , θ , ψ )}{\partial ψ}\end{matrix} ) ,$$
and
wherein the Jacobi matrix is estimated using an iterative estimation method.

7. The method according to claim 1, wherein the calculation of the relative orientation angles includes using an iterative Gauss-Newton estimator (GN estimator) to calculate the relative orientation angles.

8. The method according to claim 1, wherein the calculation of the relative orientation angles includes using an iterative Levenberg-Marquardt estimator (LM estimator) to calculate the relative orientation angles.

9. The method according to claim 1, wherein the time synchronizing of the first and second raw acceleration data and/or rotation rate data takes place via a GNSS time parameter, which the first inertial sensor and the second inertial sensor respectively receive via an associated GNSS receiver.

10. The method according to claim 1, wherein the time synchronizing of the first and second raw acceleration data and/or rotation rate data takes place with an auto-correlation function that processes the first raw acceleration data and the second raw acceleration data.

11. The method according to claim 1, wherein:
the receiving of the first raw acceleration data and/or rotation rate data includes receiving rotation rate data of the first inertial sensor in three rotation directions, and
the receiving of the second raw acceleration data and/or rotation rate data includes receiving the rotation rate data of the second inertial sensor in three rotation directions.

12. The method according to claim 1, further comprising:
receiving third raw acceleration data from at least one third inertial sensor arranged in the device,
wherein the time-synchronizing further includes synchronizing the third raw acceleration data with the first and second raw acceleration data and/or rotation rate data, and
wherein the calculating of the relative orientation angles further includes calculating relative orientation angles in three spatial directions between the first inertial sensor and the third inertial sensor and between the second inertial sensor and the third inertial sensor based on the further raw acceleration data.

13. A device comprising:
a first inertial sensor; and
a second inertial sensor,
wherein the device is configured to
receive first raw acceleration data and/or rotation rate data from the first inertial sensor in three directions during regular operation of the device;
simultaneously to receiving the first raw acceleration data and/or rotation rate data, receive second raw acceleration data and/or rotation rate data from the second inertial sensor in three directions during regular operation of the device;
time-synchronize the first raw acceleration data and/or rotation rate data of the first inertial sensor and the second raw acceleration data and/or rotation rate data of the second inertial sensor so that the time-synchronized raw acceleration data and/or rotation rate data of the first inertial sensor and of the second inertial sensor are generated; and
calculate relative orientation angles in three spatial directions between the first inertial sensor and the second inertial sensor with the time-synchronized raw acceleration data and/or rotation rate data.
